(19) United States
(12) Patent Application Publication
(10) Pub. No.: US 2007/0025703 A1
(43) Pub. Date: Feb. 1, 2007

(54) System and method for reproducing moving picture

(75) Inventor: Kimito Horie, Tokyo (JP)

Correspondence Address: NIXON PEABODY, LLP, 401 9TH STREET, NW, SUITE 900, WASHINGTON, DC, 20004-2128, US

(73) Assignee: OKI ELECTRIC INDUSTRY CO., LTD., Tokyo (JP)

(21) Appl. No.: 11/475,991

(22) Filed: Jun. 28, 2006

(30) Foreign Application Priority Data
Jul. 12, 2005 (JP) 2005-203004

(51) Int. Cl. H04N 7/00

(52) U.S. Cl. 386/96

(57) ABSTRACT

A moving-picture reproducing system has a flat panel display, a flat panel speaker group provided at the front thereof, and low-audio speakers. A video reproducing device reproduces a video from a moving-picture file and displays the same on the flat panel display. An acoustic sound reproducing device reproduces an acoustic sound and allows the flat panel speaker group and the low-audio speakers to output the same. When acoustic data reproduced from the moving-picture file by the acoustic sound reproducing device are synthesized, the synthesized data is separated into a high-frequency audio range and a low-frequency audio range by a filter. The acoustic sound of the high-frequency audio range is played back by the flat panel speaker group, and the acoustic sound of the low-frequency audio range is played back by the low-audio speakers. A sound source position reproducing device sets temporal and spatial thresholds to designate a speaker to be reproduced with a change of a speaker and performs reproduction free of uncomfortable feeling.

### BACKGROUND OF THE INVENTION

The present invention relates to a moving-picture reproducing system for capturing sound source position information of an objective and allowing a realistic moving picture to be reproduced, upon reproduction of an objective (target)-based moving picture experts group phase 4 (corresponding to a high-efficiency coding system, which is called “MPEG4”) file or the like, and a moving-picture reproducing method thereof.

The technique of adopting a high-decibel device and a vibration device to produce realistic sensations and making an appeal to the five senses of an audience through their acoustic effects and impact has appeared in recent theatrical moves. In contrast to this, the reproduction of a moving picture by a computer remains within a technique for recording and playing back video data and acoustic data of a movie in MPEG. Its reproduction is two-dimensional and do not lead up to capturing of realistic sensations.

Specifying the position and direction of a sound source by some means is considered as one technique for producing realistic sensations. For example, a technology (e.g., 3D positional sound technology) for producing a three-dimensional soundscape by two speakers has been realized. It is however difficult to show a sound source rather than “the soundscape” as if it existed in a specific position, even when speakers more than or equal to one pair are used. For instance, there is a technique for, even when only a pair of speakers exists, synthesizing the phases of acoustic waveforms and showing the sound source as if it existed in a specific position. The technique attempts to realize stereophonic reproduction by a wavefront synthesis using flat panel speakers. However, there exists the present situation that the human ears exit in a pair and their structure is complex, and hence its reproduction is not realized like a theory. Generally speaking, even though a phase synthesis is done using two speakers, the human ears have a tendency to be placed at the midpoint of their sound sources and hear as if single sound sources existed behind the speakers. This result is similar even to a case in which two or more speakers are used.

In relation to it, a technique about a three-dimensional sound image control device which has heretofore produced the sound of each individual objective lying in a three-dimensional video three-dimensionally with respect to an audience, has been described in, for example, a patent document 1 (Japanese Unexamined Patent Publication No. Hei 6(1994)-301390).

The present three-dimensional sound image control device is provided with three-dimensional video data including a three-dimensional sound signal comprising an angle θn up to each objective OJ in an image as viewed from the front with the position LNp of a listener LN as the reference, a distance rn to each objective OJ, and an acoustic sound signal Sn generated by each objective OJ in conjunction with a three-dimensional video signal of a still picture or a moving picture, a plurality of speakers SPs disposed around the listener LN, and a signal processor SI which inputs the three-dimensional sound signal (θn, rn and Sn) therein and allocates the acoustic sound signal Sn to the plurality of speakers SPs in association with the positions of the objectives OJs in the individual images. Then, the plural speakers SPs are divided into plural areas. The signal processor SI specifies by the angle θn an area in which a sound source corresponding to the objective OJ is placed, thereby to select a speaker SP to be used and calculates distance attenuation of the acoustic sound signal Sn depending on the distance rn. Thus, the three-dimensional sound signal is fetched into the signal processor SI simultaneously with the reproduction of the video signal, where processes such as the distance attenuation of the acoustic sound signal Sn, the specification of a sound image area, the selection of an output speaker, etc. are effected thereon. The so-processed three-dimensional sound signal is outputted through the selected speaker SP and thereby a three-dimensional sound image is obtained.

The three-dimensional sound image control device described in the patent document 1 is however accompanied by drawbacks that since the three-dimensional video data including the three-dimensional sound signal (θn, rn, Sn) comprising the angle θn up to each objective OJ in the image with the position LNp of the predetermined listener LN as the reference, the distance rn to each objective OJ, and the acoustic sound signal Sn is created, and the three-dimensional video data is reproduced to cause the listener LN located at each position LNp to audiovisualize or watch the three-dimensional video and the three-dimensional acoustic sound, a lot of trouble is taken with the creation of the three-dimensional video data and besides a plurality of audiences cannot watch simultaneously as in the case of TV viewing or the like, whereby it is poor in usability and lacks in general versatility.

On the other hand, in MPEG4 available for moving-picture reproduction, the idea called “Scene Description” is adopted so that a wide variety of AV (Audio Visual) objectives can be handled on a unified basis. Temporal and spatial mutual relationships between the respective AV objectives and their attributes are set so that they can be described in the scene description. The details thereof are referred to the existing standards, and only interface specs will be defined. For example, human objectives are handled as a plurality of objectives each having a sprite and sound and described in the form of object descriptors each set per each objective. However, the format of its sprite or the like remains undetermined and information about the sprite or the like is handled as an elementary stream (hereinafter called “ES”) which varies with time.

When the designation of the position of a sound source is considered as one technique for producing realistic sensations, the position of the sound source changes with time and can be handled as the ES. The position of the sound source is closely related to each objective having the sprite and sound. However, the position of the sound source is originally discrete information and has heretofore been not utilized positively in a planar or two-dimensional video using a flat panel display or a screen or the like except for a special application like such a three-dimensional video as described in the patent document 1.

### SUMMARY OF THE INVENTION

It has heretofore been difficult to specify the position of the sound source by the phase synthesis or the like as described above. As its causes, the structure of human complex ears and information processing executed by the cerebrum based on experiences, etc. are considered. It is however considered that this is not a lightly-solvable problem. It is also considered that the technology of the three-dimensional sound image control device described in the conventional patent document 1 and the like are used to solve the problem. However, the technology of the patent document 1 corresponds to a three-dimensional video/sound technology and is difficult to make the application to the solution of a conventional problem of a technology different therefrom. The present technology could not yet provide a moving-picture reproducing device and a moving-picture reproducing method to a flat panel display and a screen or the like fully satisfiable technically.

In order to solve such conventional problems, the present invention aims to provide a moving-picture reproducing system and a moving-picture reproducing method wherein the position of a sound source is designated as one technique for producing realistic sensations and the sound production of an objective can be obviously identified spatially with respect to the audience.

In order to attain the above object, the present invention adopts such a configuration that sound is directly produced from an objective position through a speaker placed in the position. It is certain that in doing so, the auditory sense of a human being can make spatial identification. However, this method also involves the following first and second problems.

The first problem is that the structure of the speaker placed in the position is limited and at least speakers large in structure cannot be disposed in large numbers. Therefore, small speakers are disposed in large numbers. In such a case, however, the frequency characteristic of the speaker presents a problem. In general, the low-audio characteristic of a small speaker is poor and its reproduction is difficult. However, the small speaker has a merit and high directivity inherent in a high-frequency audio range. On the other hand, a large speaker made especially for a low-frequency audio range is hard to reproduce a high-pitched sound and has a characteristic reduced in directivity. Thus, even a general stereophonic reproducing device makes use of a tweeter and woofer or high- and low-audio speakers together.

The second problem is that even though small speakers are disposed in large numbers and a speaker to be used is designated, the position of a sound source always varies because of moving-picture reproduction. Which speaker should be selected if a sound source position of a character is placed in a boundary region of a speaker? When any of the speaker selection methods is adopted, the sound source position makes an instable variation in turn regardless of a slight variation in the sound source position of a character, so that uncomfortable feeling will be brought to the audience. Due to the instability of an acoustic sound reproduction position, which is caused by the discrete existence of speakers, such a problem is considered to be a drawback unavoidable for this type of system.

Thus, in order to solve such first and second problems, the following first and second configurations are adopted in the present invention, which adoption is done to, when a moving-picture file like MPEG4 is reproduced, designate the position of a sound source and allow the sound production of the corresponding objective to be clearly identified spatially with respect to the audience.

The first configuration resides in that there is provided a moving-picture reproducing system having a flat panel display like a plasma display or a liquid crystal display or the like, a flat panel speaker group provided at its front or back, and low-audio speakers, wherein when acoustic data reproduced from a moving-picture file are synthesized, the synthesized data is further separated into a high-frequency audio range and a low-frequency audio range by a filter, and the acoustic sound of the corresponding high-frequency audio range is played back by the flat panel speaker group and the acoustic sound of the corresponding low-frequency audio range is reproduced by the low-audio speakers.

The second configuration resides in that temporal and spatial thresholds are set to designate a speaker to be reproduced with the changing of a speaker, and uncomfortable feeling-free reproduction is performed. There is a fear that when the speaker assigned to the reproduction is changed due to a slight variation in the reproduction position (Xm, Yn) of a sound source, the acoustic sound to be reproduced becomes instable because the speakers exist discretely alone in a finite number, and hence uncomfortable feeling is brought to an audience. Therefore, a method for setting a spatial threshold area and performing reproduction in the spatial threshold area with either a speaker currently designated upon the reproduction or an adjoining speaker is adopted

A system is adopted wherein when the position of a sound source is still placed in a threshold area, the currently selected speaker remains unchanged, and when it falls into an adjoining determination area beyond the threshold area, an adjoining speaker is selected for the first time. The temporal threshold is provided for stable acoustic sound reproduction because there is a fear that when the speaker selected within a short period of time is changed, the acoustic sound to be reproduced becomes instable alike and hence uncomfortable feeling is brought to an audience.

A silent period of the sound source is measured and a temporal threshold area is set. If a predetermined silent period has elapsed, then an adjoining speaker can be immediately selected even within the spatial threshold area. This is because the problem associated with the instability of the acoustic sound to be reproduced does not occur in this case. In this sense, the temporal threshold precedes the spatial threshold.

According to the first configuration of the present invention, the character is able to enjoy the effect of performing sound production by the acoustic sound having directivity of the high-frequency audio range by the flat panel speaker placed in the designated position as if someone existed in the corresponding position on the display. Further, since the acoustic sound of the low-frequency audio range is reproduced by the low-audio speakers, it is possible to enjoy natural acoustic sound reproduction while both are being held in cooperation.

According to the second configuration of the present invention, it is possible to solve problems for using a large number of flat panel speaker groups and enjoy natural acoustic sound reproduction. That is, when either one of the speakers is selected, the action of the threshold area makes it possible to resolve the instability of the reproduced acoustic sound, based on the change in sound source position. When the system for performing reproduction using both speakers in the threshold area is adopted, the instability of the volume can be resolved.

According to first and second aspects of the invention in particular, a character (human being or robot or the like) on a video of a moving picture can enjoy the effect of producing voice or producing a sound as if the character existed on a plane surface and would be a living being, based on acoustic directivity of a high-frequency acoustic sound, and the realistic sensation of the moving picture increases remarkably.

According to a third aspect of the invention, the operation of a spatial threshold area enables the resolution of instability of a reproduced acoustic sound, based on a spatial variation in sound source position.

According to a fourth aspect of the invention, no uncomfortable feeling occurs where a temporal first threshold is not exceeded, even when the spatial variation in the sound source position occurs. It is therefore possible to maintain natural reproduction of an acoustic sound.

According to a fifth aspect of the invention, no uncomfortable feeling occurs where a temporal second threshold is exceeded, even when the spatial variation in the sound source position takes place. It is therefore possible to maintain natural reproduction of an acoustic sound.

According to a sixth aspect of the invention, since an acoustic signal related to acoustic sound information can be reproduced by a selected speaker on the basis of sound source position information, it is possible to cause a character on a video of a moving picture and the position of a sound source for its sound production or the like to spatially coincide with each other.

According to a seventh aspect of the invention, even when reproduction must be done by the same speaker where characters or the like on a video exist close to each other, its object can be achieved by synthesizing a plurality of independent acoustic signals and leading the synthesized signal to the speaker.

According to an eighth aspect of the invention, when the amplitude of the synthesized acoustic signal becomes excessive from the result of the analog synthesis, it is possible to suppress the volume of a speaker and by extension to suppress acoustic distortion.

According to a ninth aspect of the invention, sound source position information which has heretofore been not utilized positively, can be simply captured from a moving picture as independent information.

According to a tenth aspect of the invention, since the sound source position information obtained by the acquiring method according to the ninth aspect can be compiled as data necessary for sound source position reproduction, it is convenient for handling. This is particularly advantageous to conversion into acoustic position information ES.

According to an eleventh aspect of the invention, a character (such as a human being or a robot or the like) on a video of a moving picture can enjoy the effect of producing voice or producing a sound as if the character existed on a screen and would be a living being, and hence the realistic sensation of the moving picture with respect to the audience increases remarkably.

According to a twelfth aspect of the invention, since a moving picture reproduced by an application of a computer such as a personal computer (hereinafter called “PC”) or the like can be displayed on the screen by a projector, a system according to the present invention can be easily constructed.

According to a thirteenth aspect of the invention, sound source position information is positively utilized to make it possible to reproduce an MPEG4 moving picture having realistic sensations.

According to a fourteenth aspect of the invention, sound source position information can easily be acquired and the development of an application program becomes easy.

According to a fifteenth aspect of the invention, inexpensive sound source position reproduction can be carried out without using expensive hardware, and a change of a sound source position converting method can easily be achieved.

According to a sixteenth aspect of the invention, an application program can be provided which performs sound source position reproduction matched with an acoustic system.

### BRIEF DESCRIPTION OF THE DRAWINGS

While the specification concludes with claims particularly pointing out and distinctly claiming the subject matter which is regarded as the invention, it is believed that the invention, the objects and features of the invention and further objects, features and advantages thereof will be better understood from the following description taken in connection with the accompanying drawings in which:

FIG. 1 is a schematic block diagram of a moving-picture reproducing system showing a first embodiment of the present invention;

FIG. 2 is a schematic block diagram illustrating a sound source position reproducing device shown in FIG. 1;

FIGS. 3A, 3B and 3C are diagrams depicting a specific example illustrative of the action of each threshold by the sound source position reproducing device shown in FIG. 2;

FIGS. 4A and 4B are diagrams for describing a method for selecting a designated speaker by the sound source position reproducing device shown in FIG. 2;

FIG. 5 is a diagram showing a flow for selecting a designated speaker by the sound source position reproducing device shown in FIG. 2;

FIG. 6 is a schematic block diagram showing an essential part of a moving-picture reproducing system according to a second embodiment of the present invention;

FIGS. 7A and 7B are diagrams for describing a data construction of an MPEG4 file in the moving-picture reproducing system shown in FIG. 6;

FIG. 8 is a diagram for describing a tracking operation for acquiring sound source position information of FIG. 7 from an MPEG2 video;

FIG. 9 is a diagram for describing a data structure of the sound source position information shown in FIG. 7;

FIG. 10 is a schematic configuration diagram of a theater system showing a third embodiment of the present invention; and

FIG. 11 is a schematic block diagram showing an essential part of a moving-picture reproducing system according to a fourth embodiment of the present invention.

### DETAILED DESCRIPTION OF THE PREFERRED EMBODIMENTS

Preferred embodiments of the present invention will hereinafter be described with reference to the accompanying drawings.

The present invention provides a moving-picture reproducing system wherein when a moving-picture reproducing device having a flat panel display, a flat panel speaker group provided at the front thereof and a pair of woofers or low-audio speakers synthesizes acoustic data reproduced from an MPEG4 file having character sound source position data acquired by a predetermined method, with a character being defined as an objective or object and the character sound source position data being defined as an object descriptor ID, upon reproduction of the MPEG4 file, a filter separates the synthesized data into a high-frequency audio range and a low-frequency audio range, the flat panel speaker group plays back the acoustic sound of the corresponding high-frequency audio range and the woofers play back the acoustic sound of the corresponding low-frequency audio range. This system is a system which sets temporal and spatial threshold areas per positional space (Xs, Ys) of a sound source in order to designate or specify a speaker to be reproduced.

In this case, a method is adopted wherein when the spatial threshold area is set and any speaker is selected, the currently selected speaker remains unchanged in the threshold area and a speaker adjacent thereto is selected only when an area adjacent to the threshold area is reached beyond the threshold area. A short one (Ts) of temporary thresholds is provided for stable acoustic reproduction. A long one (Tl) of the temporary thresholds is provided for measurement of a silent period. If a constant silent period has elapsed, then a method for selecting an adjoining speaker at once is adopted even if it falls within the spatial threshold area.

### First Preferred Embodiment

A first embodiment according to the present invention handles a moving-picture file having information about the position of a sound source. Particularly related in the first embodiment is the position of a sound source for an acoustic sound (including voice) generated or produced by a character, rather than the center position of the character. The number of sound sources is normally plural and the number of sound source positions is also provided plural.

The easiest acquiring method of a sound source position is a method for setting spatial positional information of an objective, particularly, a visual objective as information about the position of a sound source as it is. Even when one objective has a plurality of sound sources in this case, its positional information is limited to one. There is a case in which the position of a sound source is not clear or fixed at an audio objective. In the case of a default (initial or default settings), the position of the sound source will be placed in the point of origin. MPEG4 adopts a binary format for scene (hereinafter called “BIFS”) as a scene description language. This language is based on a Virtual Reality Modeling Language (hereinafter called “VRML”). A spatial position of an objective varies due to causes such as a user-based operation, renewal of a scene by a transmitter or sender, animation (moving picture), etc.

When, for example, the spatial position of the objective is shifted in VRML, it is described in a “translation field” in a “Transform node”. In the case of animation, a value received in a “set_translation field” in accordance with a “TimeSensor node” is passed or transferred to the “translation field”. When a user moves a visual objective by a cursor operation of a mouse corresponding to a kind of computer input device, the value of the “translation field” is changed according to a “TouchSensor node”. Thus, when such a scene description is decoded by a BIFS system decoder, it can simultaneously be supplied to a sound source position reproducing device according to the first embodiment as sound source position information.

There is a case in which a sender transmits data as streaming data called a “BIFS Animation Frame” from outside through a DMIF (Delivery Multimedia Integration Framework) interface. This is analogous to sound source position information ES handled in a second embodiment according to the present invention.

(Configuration of Moving-Picture Reproducing System of First Embodiment)

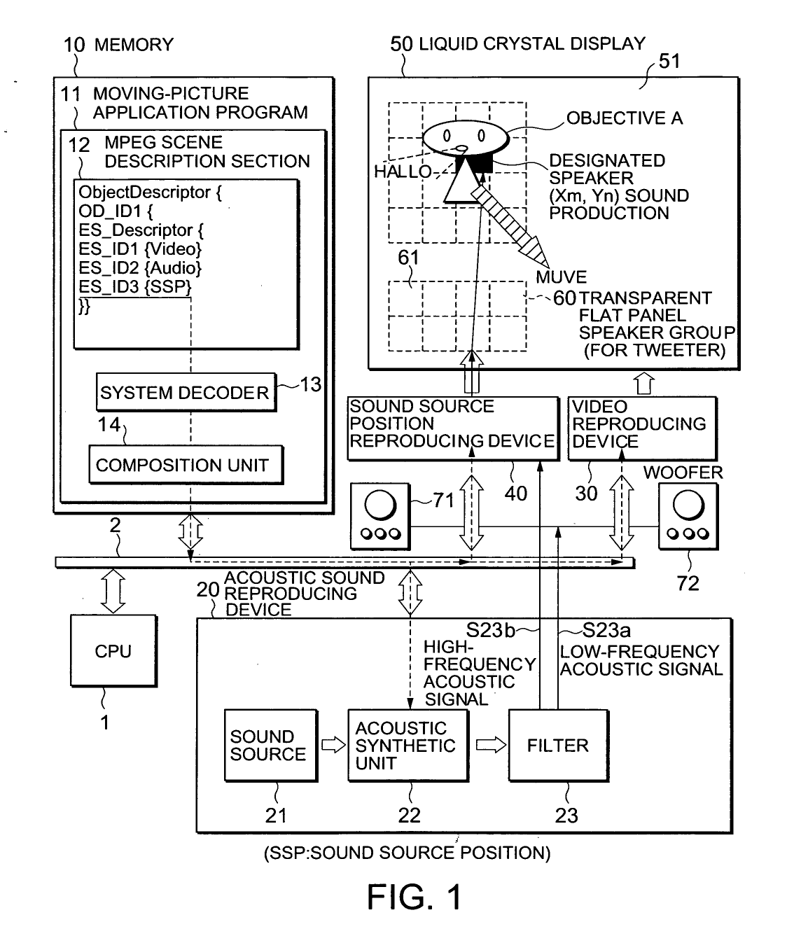

FIG. 1 is a schematic block diagram of the moving-picture reproducing system showing the first embodiment of the present invention.

The moving-picture reproducing system of the first embodiment is of an apparatus which, when a moving-picture application program 11 placed on a memory 10 accessed (read and written) by a central processing unit (hereinafter called “CPU”) 1 for controlling the entire system is executed, performs the reproduction of a moving picture based on an MPEG4 scene description, corresponding to the moving-picture application program 11.

The present moving-picture reproducing system has the CPU 1 and the memory 10 connected to the CPU 1 via a bus 2. Further, the moving-picture reproducing system is provided with an acoustic sound reproducing device 20, a video reproducing device 30 and a sound source position reproducing device 40 connected to the bus 2, a flat panel display (e.g., liquid crystal display) 50 connected to the video reproducing device 30, a transparent flat panel speaker group 60 comprising a plurality of high-audio transparent flat panel speakers 61 mounted to the front face of a liquid crystal display panel 51 thereof and connected to the sound source position reproducing device 40, and right and left low-audio speakers 71 and 72 connected to the acoustic sound reproducing device 20.

The moving-picture application program 11 stored in the memory 10 has an MPEG4 scene description section 12, a system decoder 13 and a composition unit 14. The acoustic sound reproducing device 20 is a device which decodes an acoustic objective or the like through the acoustic system decoder 13 and reproduces acoustic data subsequent to data composition by the composition unit 14 in response to the acoustic data. The acoustic sound reproducing device 20 effects acoustic composition based on acoustic data at an acoustic sound composition or synthetic unit 22, based on a sound source 21 stored in a table or the like used as memory means and thereafter outputs a low-frequency acoustic signal S23a and a high-frequency acoustic signal S23b in parts at an acoustic filter 23. The low-frequency acoustic signal S23a is played back at the low-audio speakers 71 and 72: When, however, the characteristics of the speakers 71 and 72 are allowed even on the high-pitched sound side, sticking to the reproduction of a low-pitched sound alone is not necessarily needed. Since, however, the specification or determination of a sound source position corresponding to the feature of the first embodiment is not uncertain where the reproduction of a high-pitched sound is contained, the reproduction of the high-pitched sound should be done at its limit.

The video reproducing device 30 is of a device which decodes a video objective or the like through the video system decoder 13 and reproduces video data subsequent to data composition by the composition unit 14. The video reproducing device 30 allows the liquid crystal display panel 51 to display the produced video or image. The transparent flat panel speaker group 60 comprising the plurality of high-audio transparent flat panel speakers 61 is disposed at the front of the liquid crystal display panel 51. Each of the plurality of high-audio transparent flat panel speakers 61 is constituted of, for example, a transparent sheet-like speaker comprised of a polymer piezoelectric film and a conductive polymer utilized in combination, and functions as a sound source of an objective displayed on the liquid crystal display panel 51. When the plurality of transparent flat panel speakers 61 are disposed, wirings for driving them can be formed in an area superimposed on a spatial threshold area. Since the area of the transparent flat panel speaker group 60 cannot be taken on a large scale with being restricted by the size of the liquid crystal display panel 51, the acoustic characteristic of each transparent flat panel speaker 61 can obtain a sufficient reproducing characteristic on the low-pitched sound side (100 Hz or less).

The sound source position reproducing device 40 decodes sound source position data or the like through the BIFS system decoder or the like and performs its reproduction in response to the result of decoding. The reproduction of the sound source position is performed by designating or specifying the corresponding speaker 61 (Xm, Yn) at a position (Xm, Yn) designated by the sound source position reproducing device 40 and is merely indirectly sensed as a sound reproduction position. In this sense, the reproduction of the sound source position belongs to sound reproduction. Although the sound-source position information has heretofore been positively unused, this is recognized as a third element or factor for moving-picture reproduction following an acoustic sound and video and positively utilized for the first time in the present embodiment.

When an objective A is displayed on the liquid crystal display panel 51 as its video and its voice or sound is played back, the corresponding speaker 61 designated based on the sound source position reproduction reproduces the voice. When, however, the objective A is shifted, the speaker 61 designated based on the sound source position reproduction is of course updated too. Thus, the objective A can enjoy the effect of producing a sound as if the objective A would be some living being per se.

(Configuration of Sound Source Position Reproducing Device in Moving-Picture Reproducing System)

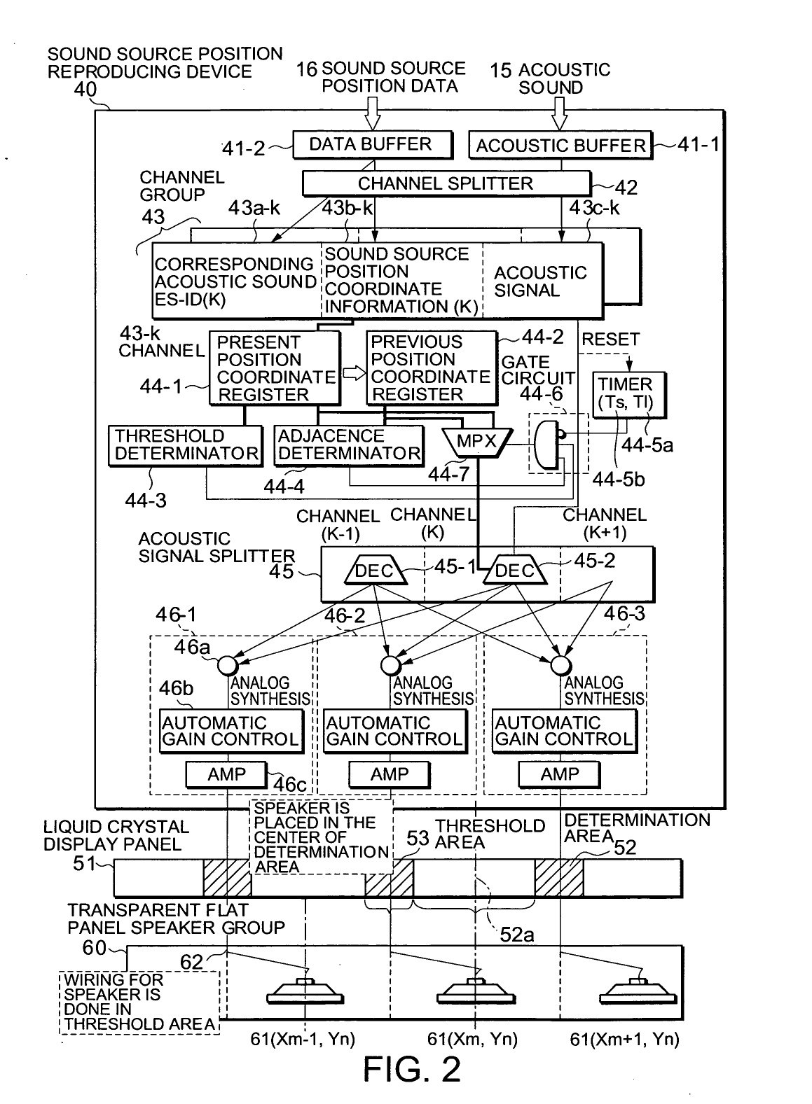

FIG. 2 is a schematic block diagram showing the sound source position reproducing device 40 shown in FIG. 1.

An acoustic sound 15 acquired by an unillustrated acoustic decoder and sound source position data 16 acquired by an unillustrated sound source position information decoder are respectively inputted to the sound source position reproducing device 40 and stored in an acoustic buffer 41-1 and a sound source position information data buffer 41-2 respectively. When acoustic data having the same ES-ID as the corresponding acoustic sound ES-ID is handled together with the sound source position data 16, the BIFS system decoder 13 is capable of avoiding the inconvenience of handling these data separately.

The sound source position data 16 stored in the data buffer 41-2 is sent to a predetermined channel buffer (one of 43a, 43b and 43c) lying in a predetermined channel of a plurality of channels 43-1, . . . that constitute a channel group 43 by a channel splitter 42 in accordance with its involvement. Here, the channels 43-1, . . . correspond to sound source position reproducing means respectively added to independent sound sources. The total number of the channels (43-1, . . . ) in the channel group 43 means the upper limit of the number of independent acoustic position playbacks handleable by the moving-picture application program 11. Since the sound source position reproducing means means an increase in hardware, there is a limit to the number of mountable channels (43-1, . . . ). Needless to say, as the number of channels (43-1, . . . ) increases, diverse acoustic environments can be constructed and hence the realistic sensation of a scene is enhanced.

The configuration of the sound source position reproducing means according to the first embodiment will next be explained by paying attention to one given channel 43-k.

Channel buffers 43a-k, 43b-k and 43c-k are provided within the channel 43-k. A corresponding acoustic sound ES-1D(k), sound source position coordinate information (k) and an acoustic or sound signal (k) allocated to the channel 43-k are respectively stored in the buffers 43a-k, 43b-k and 43c-k. The sound source position coordinate information (k) in the buffer 43b-k allocated to the channel 43-k is sequentially sent to a present position coordinate register 44-1 corresponding to a first register. The timing provided to send it thereto can also be caused to belong to an object time base (hereinafter called “OTB”) or object clock reference (hereinafter called “OCR”) of the corresponding acoustic sound ES-ID(k) in the buffer 43a-1. Alternatively, the timing can also be set so as to hold an independent OCR or the like, like acoustic position information ES handled in a second embodiment to be described later. When, however, it is controlled by an unillustrated internal control circuit, it is desirable to renew or update data at predetermined intervals with the OCR or the like as the reference. At the updated timing, the contents of the present position coordinate register 44-1 are set to a previous position coordinate register 44-2 corresponding to a second register.

A threshold determinator 44-3 and an adjacence determinator 44-4 are connected to the output sides of the present position coordinate register 44-1 and the previous position coordinate register 44-2. The threshold determinator 44-3 determines whether the present position coordinates in the register 44-1 is placed in a threshold area 53 of the liquid crystal display panel 51 or a determination area 52 of the liquid crystal display panel 51. Let's consider where, for example, when the X or Y coordinates corresponding to the present position coordinates are given as numerical values of 8 bits with the lower left of the liquid crystal display panel 51 as an origin point, the high-order or upper 4 bits thereof are allocated to their corresponding speakers 61 (thus, the number of speakers 61 can be designated as 16×16 at the maximum over the entirety of the liquid crystal panel 51 and there is however no need to select the maximum number of speakers), and the lower 4 bits thereof are used for relative location. When the threshold area 53 of the liquid crystal display panel 51 is set to the minimum, it can be determined that the present position coordinates are placed in the threshold area 53 if the value of the lower 4 bits is any of 0, 1 and F. If the value of the lower 4 bits is a value other than those, it can then be determined that the present position coordinates lie in the determination area 52 of the liquid crystal display panel 51.

When the present position coordinates in the register 44-1, which is related to the corresponding speaker 61, are compared with the previous position coordinates in the register 44-2, the adjacence determinator 44-4 determines whether an adjoining speaker 61 is selected. The adjacence determinator 44-4 judges that, for example, when sixteen speakers 61, . . . are designated according to the upper 4 bits, any thereof coincides with the X coordinates or the Y coordinates, and when the other value thereof is different by 1, an adjoining speaker 61 is selected. Whether diagonally-located speakers 61 are considered to be adjoining ones depends on the problem of design. Incidentally, since a problem associated with the instability of the position of a sound source does not occur where the same speaker 61 is designated again, the present position coordinates may be judged to exist in the determination area 52.

First and second timers 44-5a and 44-5b are connected to the output side of the channel buffer 43c-k which stores the acoustic signal (k) therein. The output sides of the timers 44-5a and 44-5b are connected to a select changeover or selector terminal of a multiplexer (MPX) 44-7 through a gate circuit 44-6. The multiplexer 44-7 is a circuit which selects either one of output signals in the registers 44-1 and 44-2 in response to a signal supplied to the select changeover terminal and outputs the same therefrom.

The first and second timers 44-5a and 44-5b are used to set temporal thresholds. The first timer 44-5a counts a short time Ts of one first threshold of temporal first and second thresholds. The first timer 44-5a is provided for stable acoustic or sound reproduction because there is a fear that when the speaker 61 selected within the short time Ts is changed, the acoustic sound to be reproduced becomes instable alike and hence uncomfortable feeling is brought to an audience. The second timer 44-5b counts a long time T1 of the second threshold of the temporal first and second thresholds and is provided for the measurement of a silent period. If a predetermined silent period has elapsed, then a problem associated with the instability of the position of a sound source does not occur even though an adjoining speaker 61 is selected immediately, even within a spatial threshold area 53a.

The first timer 44-5a triggers a reset in sync with the revision of the present position coordinates in the register 44-1 every predetermined time (update or renewal period). When a comparison with the value of the temporal threshold (Ts) is made at a position coordinate update timing and its value is not reached, the previous position coordinates in the register 44-2 are selected via the gate circuit 44-6 and multiplexer 44-7. When, however, a time interval for position coordinate updating is greater than or equal to the temporal threshold, there is no need to consider it. The reset of the second timer 44-5b is released in principle where the amplitude of the acoustic signal (k) in the buffer 43c-k is 0. However, there is considered a method wherein when a limiter is provided and its amplitude is so small that it may be ignored, the signal is judged to be silent and the count of the timer 44-5b is started. That is, the second timer 44-5b is initialized upon detection of significant amplitude. When the present position coordinates in the register 44-1 continue and the temporal threshold (T1) corresponding to the predetermined silent time has elapsed, a carry is outputted and held, so that the present position coordinates in the register 44-1 are selected through the gate circuit 44-6 and the multiplexer 44-7.

As described above, the multiplexer 44-7 selects either the present position coordinates in the register 44-1 or the previous position coordinates in the register 44-2 and uses the gate circuit 44-6 for its selection. In order to supply the position coordinates related to a selected speaker 61, the carries of the threshold determinator 44-3, adjacence determinator 44-4 and timers 44-5a and 44-5b are used in the gate circuit 44-6. Here, the gate circuit 44-6 is opened/closed in accordance with predetermined selection standards or criterions to select either the present position coordinates in the register 44-1 or the previous position coordinates in the register 44-2. As the selection criterions used here, may be mentioned first, second and third types referred to below.

According to the first selection criterion, the present position coordinates are selected where the present position coordinates in the register 44-1 are placed in the determination area 52 of the liquid crystal display panel 51. According to the second selection criterion, when the present position coordinates in the register 44-1 lie in the spatial threshold area 53a of the liquid crystal display panel 51, the present position coordinates are selected unless the present position coordinates are adjacent to the previous position coordinates in the register 44-2, whereas when the present position coordinates are adjacent to the previous position coordinates, the previous position coordinates are selected. When, however, the short time Ts of the timer 44-5a, of the temporal thresholds is not reached, the selection of the present position coordinates is not performed. According to the third selection criterion, even when the present position coordinates in the register 44-1 lie in the threshold area 53 of the liquid crystal display panel 51 and are adjacent to the previous position coordinates in the register 44-2, the present position coordinates are selected if the carry of the timer 44-5b is outputted beyond the temporal threshold (T1).

An acoustic signal splitter 45 is connected to the output side of the multiplexer 44-7. Further, a plurality of analog composition or synthetic circuits 46-1, 46-2, 46-3, . . . are connected to the output side of the acoustic signal splitter 45.

The acoustic signal splitter 45 performs the distribution of acoustic signals (k) from the channel buffer 43c-k using the determined sound source position coordinates sent from the multiplexer 44-7. The acoustic signal splitter 45 has a plurality of channels (k−1), (k), (k+1), . . . and include decoders (DEC) 45-1, 45-2, respectively provided within the respective channels (k−1), (k), (k+1), . . . . One of the decoders 45-1, 45-2, . . . is selected based on the sound source position coordinates outputted from the multiplexer 44-7. The selected decoder (45-2, for example) decodes the acoustic signal (k) for the corresponding channel (k). Each of the analog synthetic or composition circuits 46-1, . . . related to the corresponding sound source position coordinates amplifies the result of decoding and thereafter supplies the same to its corresponding speaker 61 of the speakers 61, . . . . Since wiring related to the allocation of the acoustic signals (k) is complex, it is desirable to utilize switches based on integrated circuits or the like.

Each of the analog synthetic circuits 46-1, . . . comprises an input terminal 46a corresponding to an analog synthetic or composition terminal inputted with the allocated acoustic signal (k), an automatic gain control circuit 46b which adjusts the gain of the inputted acoustic signal, and an amplifier (hereinafter called “amp”) 46c which amplifies the acoustic signal subjected to its gain control. The output sides of the respective amps 46c are respectively connected to the speakers 61 of the transparent flat panel speaker group 60 by wirings 62 via the liquid crystal display panel 51.

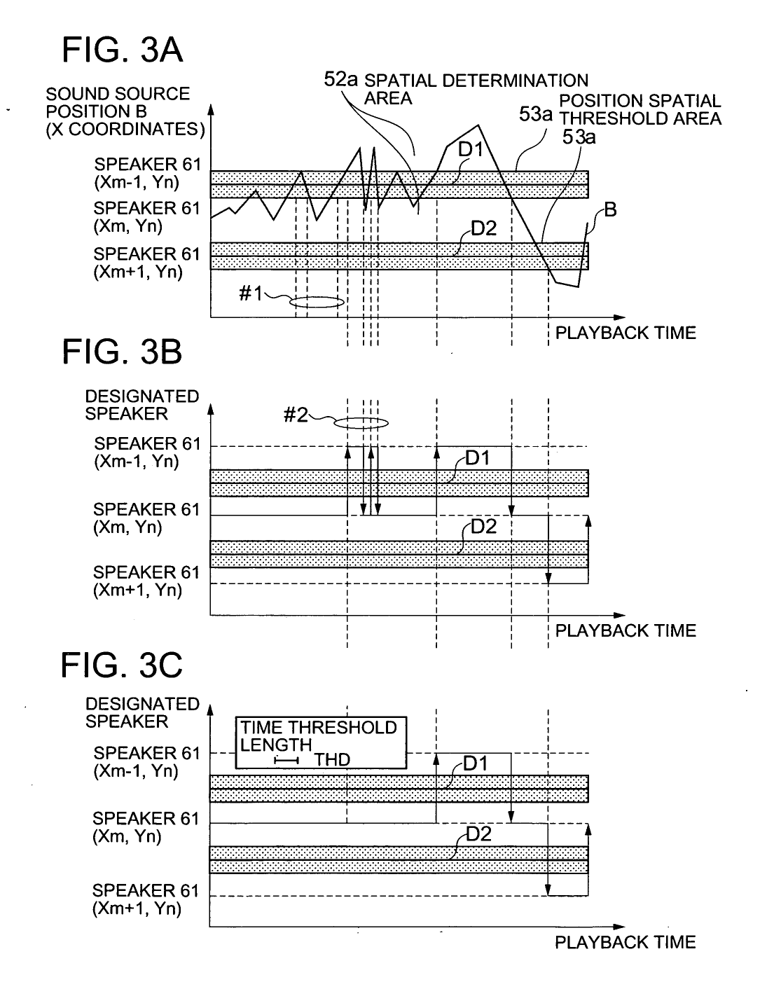

FIGS. 3(a) through 3(c) are respectively diagrams showing specific examples of the operations of thresholds employed in the sound source position reproducing device 40 shown in FIG. 2.

Of these, FIG. 3(a) is a diagram showing an example illustrative of variations in sound source position. A broken line (bold) in the figure indicates a reproduced sound source position B. For comparison, the positions of discretely-located speakers 61 (Xm−1, Yn), 61 (Xm, Yn), and 61 (Xm+1, Yn) are placed on the vertical axis, and boundary lines D1 and D2 thereof are indicated by transverse solid lines. Diagonally-shaded areas that surround the transverse solid lines indicate spatial threshold areas 53a, and blank areas indicate spatial determination areas 52a. However, only speaker locations on the X coordinates have been taken into consideration.

FIG. 3(b) is a diagram for describing the effect of each spatial threshold. The speaker 61 (Xm, Yn) is designated at the start of playback time. When the speaker remains in the threshold area 53a even though the time elapses and it is placed beyond the boundary line D1, the designation of the present speaker (Xm, Yn) is being held (#1 in the figure). Thus, the changing of the designated speaker 61 does not occur at all during such a period, and disadvantages caused by vainly changing the speaker 61 do not occur. However, the adjoining speaker 61 (Xm+1, Yn) is designated once the sound source position exceeds the threshold area 53a, and vice versa (#2 in the figure).

FIG. 3(c) is a diagram for describing the effect of each temporal threshold. There is a disadvantage in that when the temporal thresholds (Ts, T1) are not set, the change of the designated speaker 61 in FIG. 3(b) frequently takes place for a short period of time (#2 in the figure). Since, however, a time threshold length THd shown in the drawing is set and the change of designation is prohibited even if the change of designation occurs thereunder, such a disadvantage can be prevented. This effect is equivalent to the fact that when the sound source position reproduction is considered to be a waveform, high-frequency components are removed using a low-pass filter.

Now turn back to the description of the analog synthetic circuits 46-1, 46-2, 46-3, . . . shown in FIG. 2.

Acoustic signals supplied from the plurality of channels (k−1, k, k+1, . . . ) are carried onto their corresponding input terminals 46a related to the speakers 61 and subjected to a combination or synthesis by a resistance network or analog synthesis by analog addition of operational amplifiers (hereinafter “op amp”). As a result, the different channels (k−1, k, k+1, . . . ) can designate the same speaker 61. When one objective A has a plurality of sound sources and they adjoin one another, the same speaker 61 might be designated where a plurality of objectives A, . . . are displayed in superimposed form. Incidentally, since an excessive increase in the input amplitude due to the combination or synthesis of the acoustic signals supplied from the plural channels (k−1, k, k+1, . . . ) leads to degradation in sound quality, automatic gain control is made by the automatic gain control circuit 46b. Since each supplied acoustic signal is of a high-frequency acoustic signal, the amp 46c must have sufficient gain at a high frequency.

It is desirable that the speakers 61 (Xm−1, Yn), 61 (Xm, Yn), 61 (Xm+1, Yn), . . . are arranged lengthwise and crosswise in relation to the liquid crystal display panel 51 and uniformly disposed over the entire surface of the liquid crystal display panel 51. Preferably, each speaker 61 should be laid out in the center (indicated by a center line 520) of the determination area 52. When the speakers 61 are laid out evenly lengthwise and crosswise, the relationship of correspondence between the speakers can be held by the coordinates and the positions of the speakers 61. While the determination areas 52 and the threshold areas 53 are entered onto the liquid crystal display panel 51 for convenience in FIG. 2, these should be originally constructed virtually in the relationship with the positions of the speakers 61. It is advantageous that the wirings 62 of transparent electrodes relative to the speakers 61 are configured at positions corresponding to the threshold areas 53 in such a case.

Information about the layout of the objective A is placed on the liquid crystal display panel 51 and has no direct bearing on the positions of the speakers 61. Therefore, the work of allowing the sound source position coordinate information to correspond to the positions of the speakers 61 is necessary. Incidentally, the transparent flat panel speaker group 60 is placed at the front of the liquid crystal display panel 51. It is not realistic to lay out the speaker group 60 at the rear of the liquid crystal display panel 51 in terms of the complex configuration of the liquid crystal display panel 51 and the acoustic characteristic of each speaker 61. The transparent flat panel speakers 61 are constituted of the polymer piezoelectric film or the like, and marks for the speakers 61 in FIG. 2 are merely illustrations of symbolic images.

(Method for Selecting Designated Speaker)

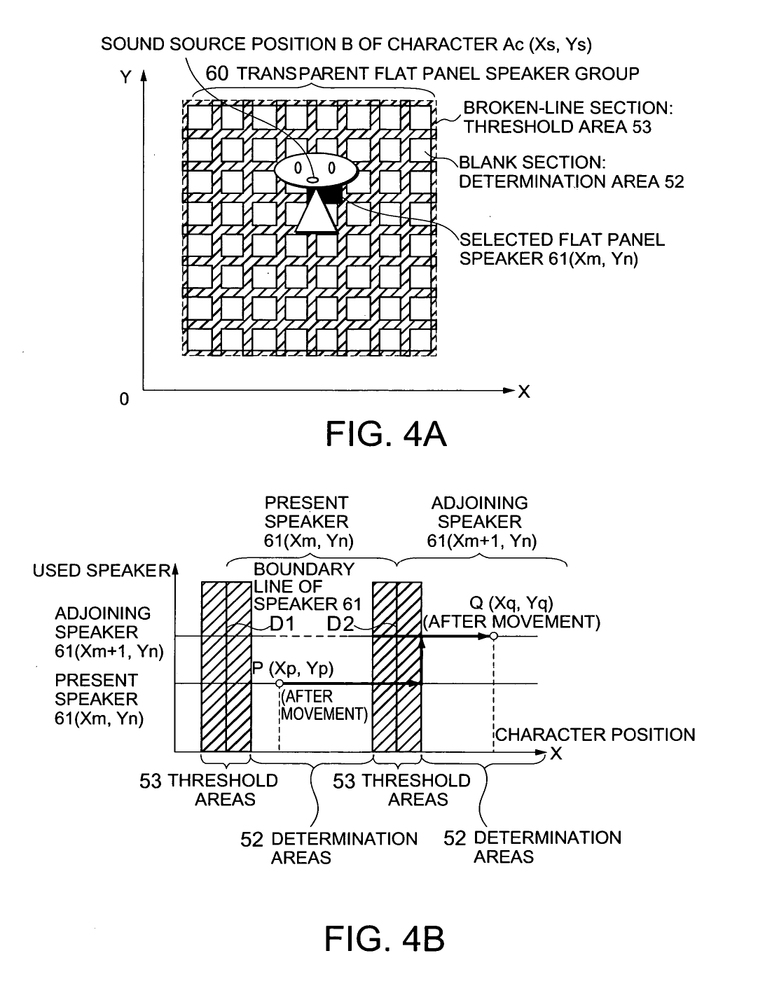

FIGS. 4(a) and 4(b) are respectively diagrams for describing a method for selecting a designated speaker by the sound source position reproducing device 40 shown in FIG. 2.

Of these figures, FIG. 4(a) is a diagram showing a spatial threshold area 53a set onto the liquid crystal display panel 51.

A threshold area 53 (broken-line section) and determination areas 52 (blank sections) are defined corresponding to a transparent flat panel speaker group 60 represented in the form of 8×8, for example. Although the sound source position B of the displayed objective A and the layout or location of each flat panel speaker 61 are not necessarily coincident with each other as described above, they are now assumed to coincide with each other for convenience of explanation. In FIG. 4(a), a character Ac is represented as a video or image objective, and a sound objective incidental to the character Ac is normally placed on the origin of a scene. Thus, the sound source position B (Xs, Ys) of the character Ac has heretofore been not necessarily defined as the displayed center position of the character Ac, much less the position of an organ or the like corresponding to a sound source in fact. In the first embodiment, the transparent flat panel speaker 61 (Xm, Yn) placed in the position adjacent to the oral cavity of the character Ac is selected.

FIG. 4(b) is a diagram for describing the action of the spatial threshold area 53a set onto the liquid crystal display panel 51.

In the plane surface shown in FIG. 4(b), the X-axis indicates only the X coordinates Xs of the position (Xs, Ys) of the character Ac, and the Y coordinates Ys are fixed. The character position corresponds to the position on the liquid crystal display panel 51 simultaneously and defines the threshold area 53 (broken-line section) and the determination areas 52 (blank sections). The Y-axis indicates a speaker 61 (Xm, Yn) to be used. The coordinates Xm take discrete values per Xm (m=0-7), and the coordinates Yn (n=0-7) are fixed. FIG. 4(b) shows a case in which the sound source position B is initially placed in a point P (Xp, Yp) and thereafter shifted or moved to reach a point Q (Xq, Yq). Its movement is continuous or discontinuous, and the selected speaker 61 remains unchanged when the character position Xs stays in the same determination area 52. When the sound source position stays in the right and left threshold areas 53 even beyond a boundary line D2 thereof, the speaker acts in similar fashion. Once, however, the sound source position enters an adjoining determination area 52 beyond the threshold area 53, an adjoining speaker 61 (Xm+1, Yn) is selected and the original speaker 61 is not selected immediately even though the sound source position is returned to the threshold area 53. As a result, the unnecessary instability of the selected speaker 61 can be solved by virtue of the action of the spatial threshold area 53a even if the character position is shifted continuously or discontinuously. Incidentally, the provision of temporal thresholds (Ts, T1) assumes an exception.

(Flow for Selection of Designated Speaker)

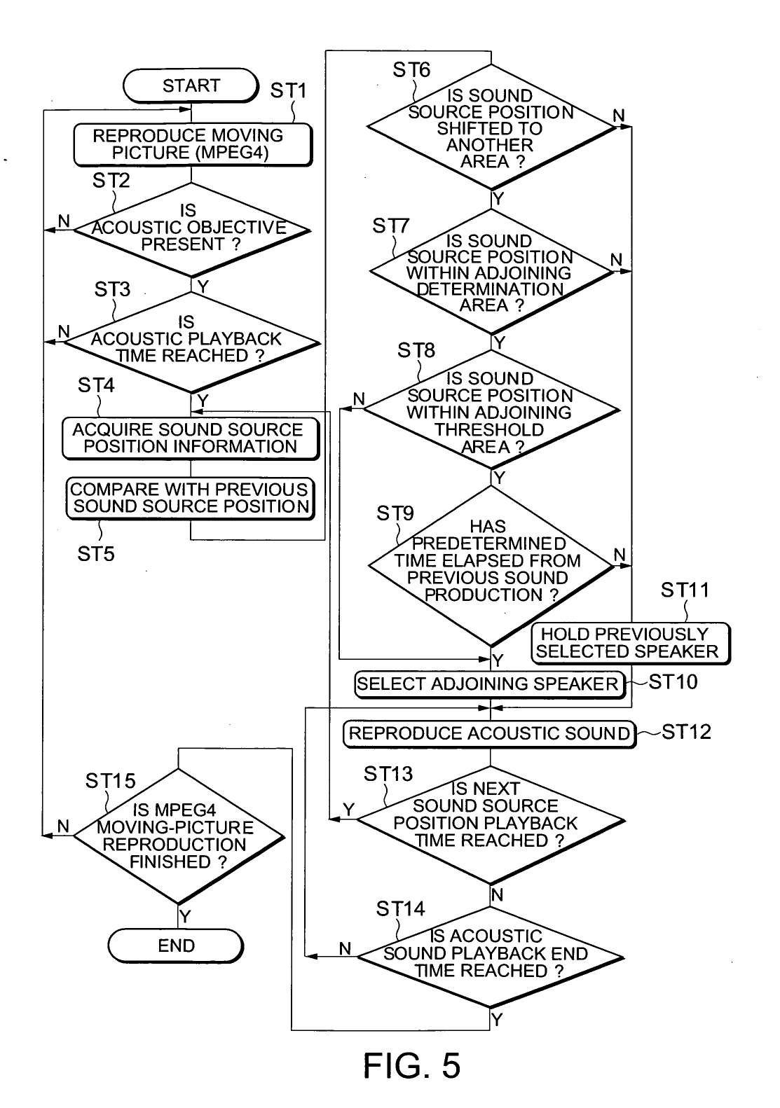

FIG. 5 is a diagram showing a flow for the selection of a designated speaker, which is executed at the sound source position reproducing device 40 shown in FIG. 2. The operation of the sound source position reproducing device 40 shown in FIG. 2 will be explained with reference to FIG. 5.

When the operation of the sound source position reproducing device 40 is started, the sound source position reproducing device 40 firstly reproduces or plays back an MPEG4 moving picture (Step ST1). When an acoustic objective exists (Step ST2) and an acoustic playback time is reached (Step ST3), the sound source position reproducing device 40 acquires or captures sound source position information (Step ST4) to select a speaker 61 through which acoustic playback or reproduction is done. Next, the sound source position reproducing device 40 determines by comparison whether a sound source position B of the acoustic objective coincides with a previous sound source position B or different therefrom (Step ST5). When they are found to coincide with each other (Step ST6), the previously-selected speaker 61 is selected as it is (Step ST11).

When a new sound source position B lies in a determination area 52 or a threshold area 53 equivalent to a different speaker 61, the sound source position reproducing device 40 next determines by comparison whether the corresponding new area is adjacent to a previous area (Step ST7). When it is found not to be the adjoining area, the previously-selected speaker 61 is selected as it is. This is because it is natural that the speaker 61 to be selected may also be changed with respect to a large change in the sound source position B. Incidentally, whether it is determined that diagonally-located areas adjoin each other depends on the problem of design.

When the new sound source position B lies in a threshold area 53 of an adjoining speaker 61 (Step ST8), the sound source position reproducing device 40 next checks for temporal thresholds (Ts, T1) (Step ST9). When a predetermined silent time has elapsed from previous sound production by the timer 44-5a, the change of the selected speaker 61 does not give rise to uncomfortable feeling. Therefore, when the predetermined time has already elapsed, an adjoining speaker 61 is selected (Step ST10). If not so, then the previously-selected speaker is held (Step ST11).

When the selected speaker 61 is decided, the playback of an acoustic sound with the reproduction of the MPEG4 moving picture is performed through the speaker 61 (Step ST12). Since the acoustic sound reproduction and the sound source position reproduction are discrete information as described above, the sound source position reproduction is performed every moment even during the acoustic sound reproduction. However, the sound source position reproduction does not necessarily require continuous reproduction. Even though the discrete values are adopted, uncomfortable feeling is not given so much unlike the acoustic sound reproduction. Thus, in the first embodiment, the sound source position reproduction is performed at predetermined time intervals and a decision as to whether its playback time is reached is made (Step ST13).

When the playback time is reached, the next sound source position information is acquired (Step ST4). When the acoustic sound reproduction is finished (Step ST14), the sound source position reproduction is also stopped depending upon it. When the acoustic sound reproduction is finished and the playback of a moving picture is not yet completed (Step ST15), the sound source position reproducing device 40 waits for the appearance of a new acoustic objective (Steps ST1 and ST2). If the moving-picture playback is finished, then the acoustic sound reproduction and the sound source position reproduction are also completed.

(Advantageous Effects of First Embodiment)

According to the first embodiment, the following effects like (1) and (2) are brought about.

(1) In the first embodiment, the moving-picture reproducing system having the liquid crystal display 50, the transparent flat panel speaker group 60 provided at its front, and the low-audio speakers 71 and 72 is configured in such a manner that when acoustic data reproduced from the moving-picture application program 11 are synthesized by the acoustic synthetic unit 22 of the acoustic sound reproducing device 20, the synthesized data is further separated into the high-frequency audio range and the low-frequency audio range by the filter 23, and the acoustic sound of the corresponding high-frequency audio range is played back by the transparent flat panel speaker group 60 and the acoustic sound of the corresponding low-frequency audio range is reproduced by the low-audio speakers 71 and 72.

With the adoption of such a configuration, the corresponding character Ac is able to enjoy the effect of producing sound by the acoustic sound having directivity of the high-frequency audio range by the flat panel speaker 61 placed in the designated position as if someone existed in the corresponding position on the liquid crystal display panel 51. Further, since the acoustic sound of the low-frequency audio range is reproduced by the low-audio speakers 71 and 72, it is possible to enjoy natural acoustic sound reproduction while both are being held in cooperation.

(2) In the first embodiment, the temporal and spatial thresholds are set to designate the speaker 61 to be reproduced with the change of the speaker, whereby the reproduction free of uncomfortable feeling is carried out. There is a fear that when the speaker 61 which handles reproduction is changed due to a slight variation in the reproduction position (Xm, Yn) of the sound source, the acoustic sound to be reproduced becomes instable because the speakers 61 are finite in number and exist only discretely, so that the uncomfortable feeling is brought to the audience. Therefore, there has been adopted a method for setting the spatial threshold area 53a and performing reproduction by either the currently designated speaker (e.g., 61 (Xm, Yn)) or its adjoining speaker (e.g., 61 (Xm+1, Yn)) upon reproduction at the spatial threshold area 53a.

That is, there is adopted a method wherein when the sound source position B is still placed in the threshold area 53, the currently-selected speaker 61 (Xm, Yn) remains unchanged, and when the sound source position B enters the adjoining determination area 52 beyond the threshold area 53, the adjoining speaker 61 (Xm+1, Yn) is firstly selected. The temporal thresholds Ts is provided for stable acoustic sound reproduction because there is a fear that when the selected speaker 61 is changed within a short period of time, the reproduced acoustic sound becomes instable alike and uncomfortable feeling is brought to the audience.

A silent period of the corresponding sound source is measured and the silent period threshold Tl is set. If a predetermined silent period Tl has elapsed, then an adjoining speaker 61 (Xm+1, Yn) can be selected immediately even within a spatial threshold area 53a. This is because the problem associated with the instability of the reproduced acoustic sound doe not occur in this case. In this sense, the temporal thresholds (Ts, T1) precede the spatial threshold.

Thus, according to the configuration of the first embodiment, it is possible to solve the problems for using the transparent flat panel speaker group 60 and enjoy natural acoustic sound reproduction. That is, when any speaker 61 is selected, the instability of the reproduced acoustic sound based on the variation in the sound source position B can be resolved by virtue of the action of the threshold area 53. Adopting the system for performing reproduction using both speakers 61 (Xm, Yn) and 61 (Xm+1, Yn) in the threshold area 53 makes it possible to resolve the instability of sound volume.

### Second Preferred Embodiment

(Configuration of Moving-Picture Reproducing System According to the Second Embodiment)

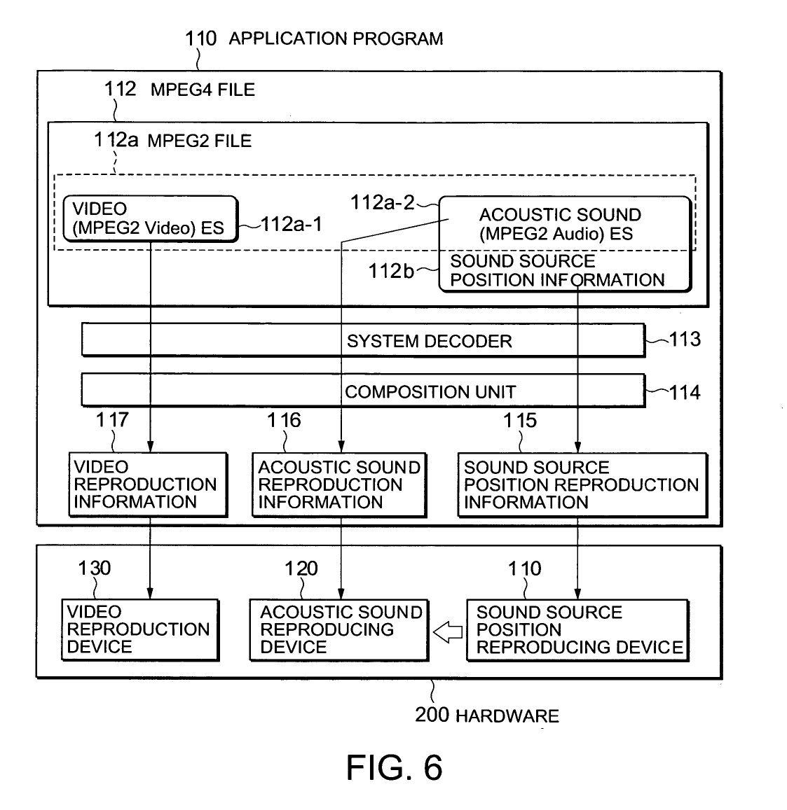

FIG. 6 is a schematic block diagram showing an essential part of a moving-picture reproducing system according to the second embodiment of the present invention.

The moving-picture reproducing system has an application program 110 corresponding to the moving-picture application program 11 of FIG. 1 showing the first embodiment, and hardware 200 controlled by the program 110. The hardware 200 has an acoustic sound reproducing device 120, a video reproducing device 130 and a sound source position reproducing device 140 respectively corresponding to the acoustic sound reproducing device 20, the video reproducing device 30 and the sound source position reproducing device 40 shown in FIG. 1.

The moving-picture reproducing system according to the second embodiment is a system which handles sound source position information as ES and performs moving-picture reproduction associated with MPEG2 video. This is a system wherein since the sound source position information is held in cooperation with the MPEG2 video, a variation in the position of a character objective is not taken into consideration. The application program 110 includes an MPEG4 file 112, an MPEG2 system decoder 113 and a composition unit 114 respectively corresponding to the MPEG4 scene description section 12, the system decoder 13 and the composition unit 14 shown in FIG. 1 showing the first embodiment and has the function of outputting sound source position playback or reproduction information 115, acoustic sound reproduction information 116 and video reproduction information 117 to the hardware 200.

The MPEG2 file 112 has sound source position information as ES (112b) in addition to an MPEG2 file 112a having a video (MPEG2 video) ES112a-1 and an acoustic sound (MPEG2 audio) ES112a-2. While an MPEG4 video and an MPEG4 audio other than the MPEG2 video or the like can also be selected, the system according to the second embodiment is advantageous to the placement of emphasis on the fact that it is of a new moving-picture reproducing system which demarcates the conventional moving-picture playback or reproduction.

The MPEG2 system decoder 113 decodes a video (MPEG2 video) ES112aP-1 and an acoustic sound (MPEG2 audio) ES112a-2 supplied from the MPEG2 file 112a and outputs the video playback information 117 and acoustic sound playback information 116 respectively. The composition unit 114 synthesizes results of decoding by the MPEG2 system decoder 113. The result of synthesis is effectively available in an application such as an MPEG4 playback player or the like.

The playbacks of the video reproduction information 117 and acoustic sound reproduction information 116 are respectively realized by the video reproducing device 130 like a liquid crystal display and the acoustic sound reproducing device 120 like a speaker with an amplifier in the hardware 200. Since the reproduction of a sound source position belongs to acoustic sound reproduction although the playback of the sound source position reproduction information 115 is carried out by the sound source position reproducing device 140, the sound source position reproduction information 115 is supplied to the acoustic sound reproducing device 120 and used for selection control on a playback speaker or the like of the acoustic sound reproducing device 120.

(Data Construction of MPEG4 File)

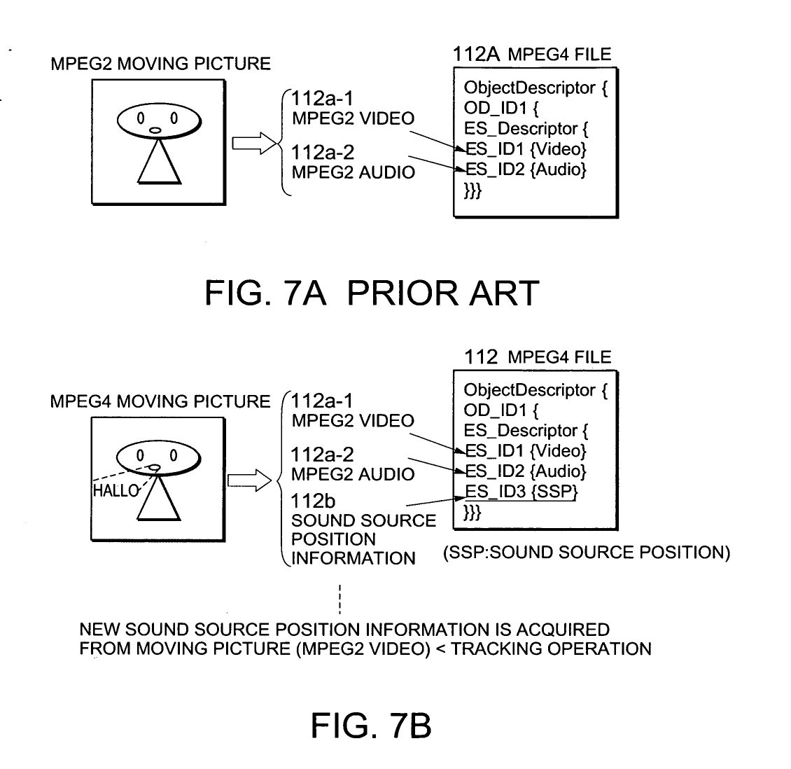

FIGS. 7(a) and 7(b) are respectively diagrams for describing a data construction of the MPEG4 file 112 shown in FIG. 6.

Of these figures, FIG. 7(a) shows the data construction of the conventional MPEG4 file 112A. A video ES_ID1 and an acoustic sound ES_ID2 can be respectively supplied from the MPEG2 file 112a as an MPEG2 video (112a-1) and MPEG2 audio (112a-2). For the MPEG2 audio (112a-2), techniques to bring about three-dimensional acoustic effects by a 5.1 channel (CH) speaker configuration have appeared in recent times. However, they are not techniques for making use of at least the sound source position information (112b).

On the other hand, the data construction of the MPEG4 file 112 according to the second embodiment shown in FIG. 7(b) is different from the conventional one in that the MPEG4 file is accompanied by sound source position information ES_ID3 in addition to the video ES_ID1 and acoustic sound ES_ID2. Such sound source position information ES_ID3 can be acquired from the MPEG2 video (112a-1) by a tracking operation to be described later. The acquired sound source position information ES_ID3 is supplied to the system decoder 113 in the form of the sound source position information 112b with the MPEG4 file 112 as a source and played back as the sound source position reproduction information 115, followed by being used for selection control on the playback speaker or the like of the acoustic sound reproducing device 120.

(Tracking Operation for Acquiring Sound Source Position Information)

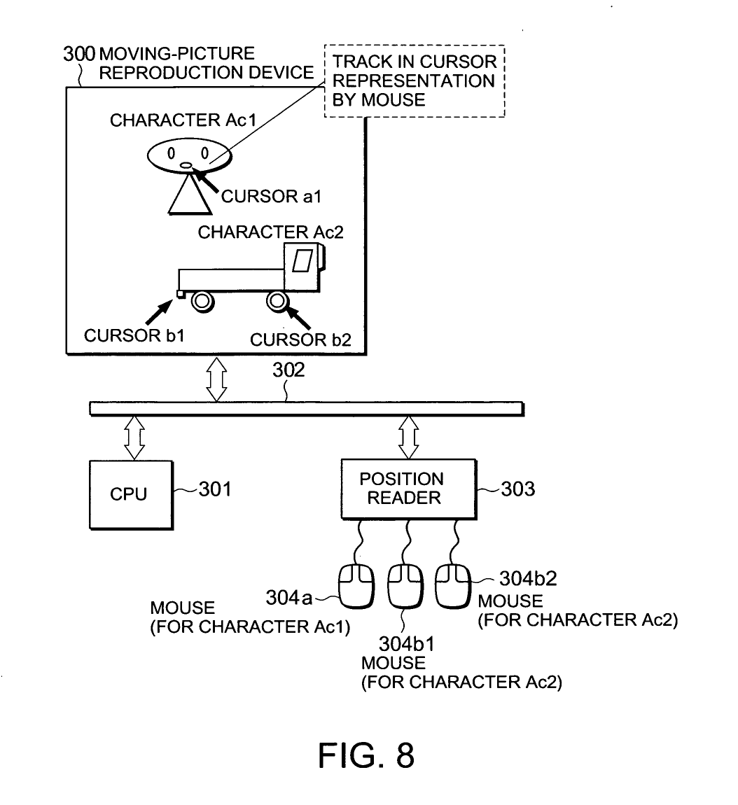

FIG. 8 is a diagram for describing a tracking operation for acquiring the sound source position information (112b) of FIG. 7 from an MPEG2 video.

The tracking operation for obtaining the sound source position information (112b) makes use of a PC, for example. In this PC, a moving-picture reproducing device 300 with a display screen and a CPU 301 which controls its entirety are connected to a PC internal bus 302. A position reader 303 is connected to the internal bus 302, and a plurality of mice (such as a mouse 304a for a character Ac1, a mouse 304b1 for a character Ac2 and a mouse 304b2 for a character Ac2) are connected to the position reader 303.

A plurality of characters (such as a human character Ac1 and a car character Ac2) are displayed on the display screen of the moving-picture reproducing device 300. The human character Ac1 has an oral cavity and produces sound. Thus, the oral cavity is used as its sound source and its position can be defined as a sound source position. When moving-picture reproduction is executed and the character Ac1 is shifted, its sound source position is also moved as a matter of course. In the second embodiment, for example, one cursor a1 is assigned to the same sound source, and an operator moves the mouse 304a to track the corresponding sound source. The cursor a1 of the mouse 304a is always held in the position of the oral cavity. In doing so, the position reader 303 connected with the mouse 304a is capable of capturing the coordinates of the cursor a1 as the coordinates of the sound source position. Incidentally, as other configurational example, such a system as to capture the coordinates of the cursor as the coordinates of the sound source position can be constructed even by a combination of a projector, a laser pointer and a laser light reader.

There is also a case in which tracking becomes difficult. When, for example, a given character suddenly appears at the boundary of a scene, it might be difficult to locate the cursor in unison with sound production. In this case, the playback speed of the moving-picture reproducing device 300 is lowered and the moving-picture reproducing device 300 must track the cursor in slow motion. When the sound source position exists outside the scene, e.g., an exhaust sound of a faraway airplane has no option but to be designated at a position considered to be farthest, e.g., one end of the display screen. When a wide acoustic region exists as in background noise or the like, it is desirable to perform simultaneous reproduction by a plurality of speakers. It should be noted that the sound source position is not necessarily limited to one per character, and sound sources other than the character also exist in large numbers.

Particularly related in the second embodiment is not the center position of the character but the position of a sound source of an acoustic sound (containing voice) produced by the character. The number of sound sources is normally plural and sound source positions are provided in plural form. For example, the car character Ac2 has a plurality of sound sources such as a warning sound which produces a horn, an exhaust sound produced by a muffler, other sound of friction between a road surface and each tire, etc. In the second embodiment, a cursor b1 is assigned to the muffler sound and a cursor b2 is assigned to the warning sound, and the mouse 304b1 and the mouse 304b2 track them respectively.

There is no doubt that such a tracking operation is easy for computer-created animation. This is because the computer is capable of handling the entire character as one objective in its application program. It is however considered that there is not yet known a case in which sound source position information is positively utilized in the prior art. It is estimated that such a demand would not be made in the conventional display device and acoustic device. In the second embodiment, sound source position information necessary upon the input of each position by a tracking operator is acquired.

A data structure example most suitable for sound source position data captured by such a tracking operation will be examined.

The captured sound source position data has a close connection with moving-picture acoustic data. When, for example, the acoustic sound of a moving picture is silent, the sound source position data does not make sense. When the moving-picture acoustic sound is coded in MPEG2, all the acoustic sounds can be described in one file in a synthesized form. On the other hand, when the moving-picture acoustic sound is defined every objective A as in MPEG4, there is a need to perform the work of individually acquiring sound source position information. However, the work of acquiring the sound source information every objective A is not difficult. After Recoding is common even in the case of movies and animation. Upon recording, however, voice and sound effects are recorded individually and must be allocated to the objective A of the MPEG4 file 112. Incidentally, since the intended objective A does not exist where the sound source position exists outside a scene, a virtually-set objective (hereinafter called “virtual objective”) is constructed. Although the virtual objective can also be constructed in plural form, one virtual objective can be constructed as one having a large number of attributes and ES because its material substance is not represented. When it has a broad acoustic region as in the background noise or the like, a system can be adopted which includes a plurality of sound source positions B and simultaneously plays back the same acoustic sounds ES.

As described above, MPEG4 is set such that the temporal and spatial mutual relationships between the respective AV objectives and their attributes can be described in a scene statement or description. The details thereof are referred to the existing standards and only interface specs are defined. It is however considered that the existing data format which suitably describes the sound source position data, is not yet known. Therefore, such a data format as shown in FIG. 7 is adopted in the second embodiment.

(Data Structure of Sound Source Position Information)

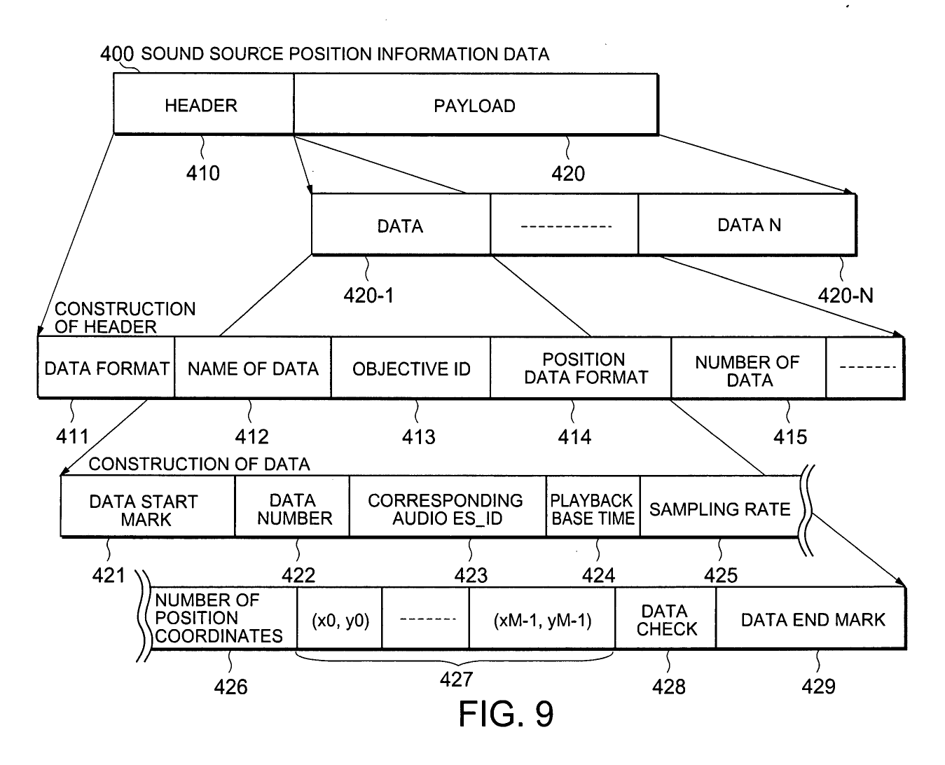

FIG. 9 is a diagram for describing the optimum data structure of the sound source position information shown in FIG. 7.

The whole span of the sound source position information data 400 comprises a header 410 and a data payload 420. The header 410 can be configured so as to include information for specifying its data format 411, the designation or name 412 of data given to the sound source position information, an object ID 413 to which the sound source position information belongs, a position data format 414 of the position information involved, the number of data 415, and other total byte length, etc. Each data 420-1, . . . in a plurality of data 420-1 through 420-N that constitute the data payload 420 can be constructed so as to include a data start mark 421, a data number 422, an ID (corresponding audio ES_ID) 423 of an acoustic sound ES corresponding to the data, a playback base time 424, a sampling rate 425, the number of position coordinates (M) 426, position coordinate data 427 sampled at times (x0, y0) through (xM−1, yM−1), a data check 428 such as parity or the like, and a data end mark 429, etc.

Since the data format of the sound source position information involved is not limited to the format specifically shown in FIG. 7, there is a need to specify the format. The objective A to which the sound source position information belongs is assumed to contain a virtual objective as well. Since a plurality of sound sources might exist in one objective A, it is necessary to definitely designate to which acoustic sound ES each data belongs. The playback base time 424 conforms to OCR of the acoustic sound ES or the like in principle but is described here where it varies.

In the sampling rate 425, a sampling period at a tracking operation is used as the reference and its value depends upon the speed of moving-picture reproduction. Since it is common that the movement of the sound source position B is limited to a range in which the auditory sense of a human being can track the objective A, the sampling rate 425 also results in a unit ranging from 50 ms through 1000 ms. The range of the position coordinate data 427 is relatively set and depends on the size of the liquid crystal display panel 51 or the like and the size of the transparent flat panel speaker 61 or the like. Thus, it is desirable to represent it in a relative position at a full-screen display. Since it is difficult to reduce the size of the transparent flat panel speaker 61 or the like and arrange it in large numbers, the accuracy of 1 byte or so is enough for the relative position.

(Advantageous Effects of Second Embodiment)

According to the second embodiment, such advantageous effects as shown in the following (1) through (4) are further brought about in addition to advantageous effects approximately similar to the first embodiment.

(1) The moving-picture reproducing device 300 in the PC shown in FIG. 8 reproduces moving pictures and tracks the sound source positions of their video characters Ac1 and Ac2 by the cursors a1, b1 and b2 associated with one or plural mice 304a, 304b1 and 304b2 to obtain sound source position information, and acquires the produced acoustic sounds of the characters Ac1 and Ac2 in association with the sound source position information. Therefore, the sound source position information which has heretofore been not utilized positively, can easily be captured from the moving pictures as independent information.

(2) The method of constructing the data having the designation of the acoustic data corresponding to the characters, the playback base time, the sampling rate and the plural position coordinates as shown in FIG. 9 as the sound source position information data 400 having the sound source position information acquired at the above (1) is adopted. Therefore, since the acquired sound source position information can be compiled as data necessary for sound source position reproduction, it is convenient for handling. This is particularly advantageous to conversion into the acoustic position information ES.

(3) Since the moving-picture reproducing method for supplying or providing the sound source position information data 400 having the designation of the corresponding acoustic data, the playback base time, the sampling rate and the plural position coordinates to the BIFS system decoder 113 as MPEG4ES which belongs to the acoustic sound ES related to the acoustic data, and setting the reproduced sound source position as the element for the composition (114) is adopted as shown in FIG. 9, the sound source position information can be utilized positively and the realistic reproduction of the MPEG4 moving picture can be carried out.

(4) Since the moving-picture reproducing method for setting the spatial position of the objective corresponding to the element for the composition (114) as the sound source position is adopted as shown in FIG. 6, the sound source position information can be simply acquired and the development of the application program 110 or the like becomes easy.

### Third Preferred Embodiment

(Theater System of Third Embodiment)

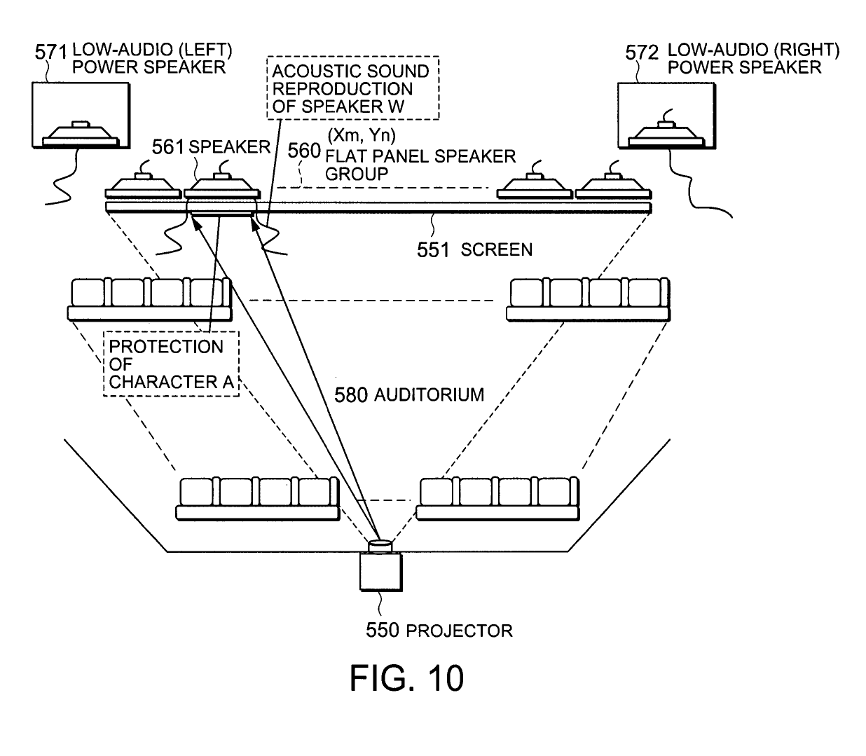

FIG. 10 is a schematic block diagram of a theater system showing the third embodiment of the present invention.

The theater system is equivalent to one in which the moving-picture reproducing systems according to the first and second embodiments are applied. The theater system is merely large-scaled upon its implementation and basically similar to the first and second embodiments.

In the theater system according to the third embodiment, for example, a projector 550 is provided in place of the liquid crystal display 50 of FIG. 1 showing the first embodiment, a large-sized projection screen 551 is provided instead of the liquid crystal display panel 51 shown in FIG. 1, a flat panel speaker group 560 comprising a plurality of flat panel speakers 561 disposed at the rear side of the screen 551 is provided as an alternative to the transparent flat panel speaker group 60 shown in FIG. 1, a low-audio power speaker 571 on the left side and a low-audio power speaker 572 on the right side both of which are disposed on the right and left of the screen 551 are provided in place of the low-audio power speakers 71 and 72 shown in FIG. 1, and an auditorium 580 newly disposed between the projector 550 and the screen 551 is provided, respectively.

That is, a spatial threshold area or the like is formed with respect to the flat panel speaker group 560 (Xm, Yn) to resolve the instability of acoustic sound reproduction with the shift of a sound source. There is no need to dare to place the flat panel speaker group 560 at the front of the projection screen 560 because of the merely theater system. Since a large one can be adopted as the speaker 561, a distinction between a high-frequency acoustic sound and a low-frequency acoustic sound is not necessarily required. However, the low-audio power speakers 571 and 572 are effective to form a powerful playback sound. To this end, the flat panel speaker group 560 is placed in the center and the low-audio power speakers 571 and 572 are disposed on the right and left sides.

When the projector 550 projects a character A onto the screen 551 with the auditorium 580 in between, the speaker 561 placed in its position can be allocated to the sound production of the character A. Thus, the audience in the auditorium 580 can enjoy the effect of producing voice or producing a sound as if the character A on the screen 551 were a living being, and the realistic sensation of each moving picture to the audience increases markedly.

(Moving-Picture Reproducing System Using Projector)

A presentation system, which projects a computer-produced video picture or image on the screen 551 by the projector, has become widespread in recent years. Even in this case, such moving-picture reproduction that the flat panel speaker group 560 disposed at the back of the screen 551 or provided integrally with the screen 551 is disposed, is enabled. In such a case, it is possible to make use of moving-picture reproduction using such an application program 110 as shown in FIG. 6 by the computer such as PC or the like. If the acoustic sound reproduction is executed without distinguishing the high-frequency acoustic sound and the low-frequency acoustic sound from each other, then simple acoustic sound position reproduction can be realized using the externally-provided sound source position reproducing device 140 shown in FIG. 6 by way of example.

### Fourth Preferred Embodiment

(Configuration of Moving-Picture Reproducing System)

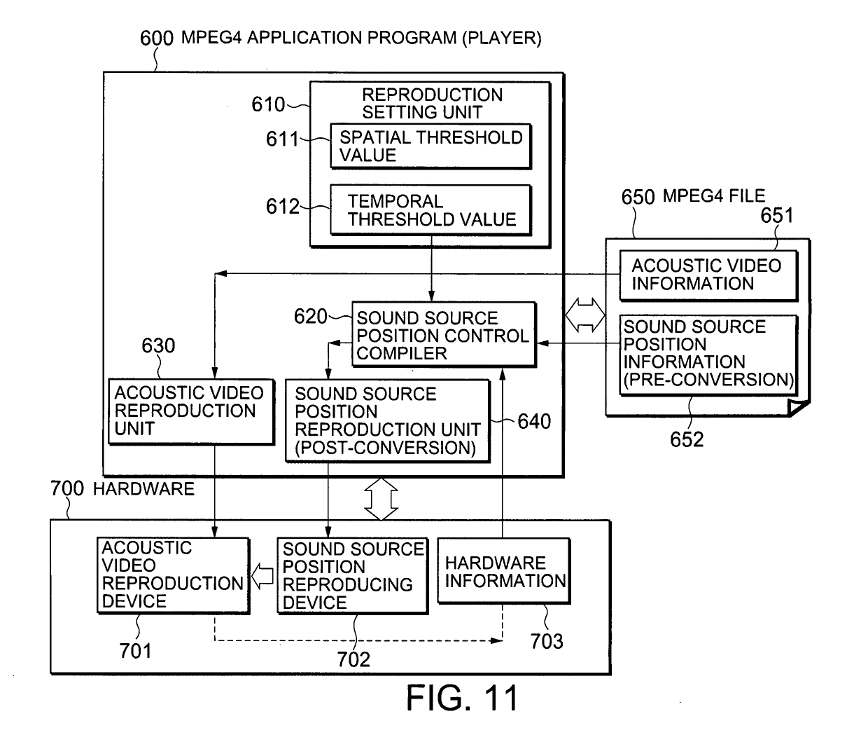

FIG. 11 is a schematic block diagram showing an essential part of a moving-picture reproducing system according to a fourth embodiment of the present invention.

When spatial and temporal thresholds are implemented by software, it can be realized at low cost without using complex hardware. However, contrivance to capture hardware information and convert sound source position information to the optimum form is required. One to which such contrivance has been made is of the moving-picture reproducing system according to the fourth embodiment.

The moving-picture reproducing system according to the fourth embodiment is of a system using a sound source position control compiler corresponding to sound source position conversion software and has a player 600 corresponding to an MPEG4 application program, and hardware 700 controlled by it. Upon playing back an MPEG4 file 650, the player 600 reproduces not only sound source video information 651 contained in the file 650 but also pre-conversion sound source position information 652 contained in the file 650.

When a spatial threshold value 611 or a temporal threshold value 612 is set in default or by an operator's setting at a playback or reproduction setting unit 610 lying in the player 600, the sound source position control compiler 620 corresponding to the sound source position conversion software converts the pre-conversion sound source position information 652 to post-conversion sound source position information in accordance with the setting. The player 600 performs acoustic video reproduction at an acoustic video reproducing unit 630 and carries out sound source position reproduction at a post-conversion sound source position reproducing unit 640 in accordance with the acoustic video information 651 and the post-conversion sound source position information, respectively. These are respectively played back by an acoustic video reproducing device 701 and a sound source position reproducing device 702 that constitute the hardware 700. Further, the sound source position reproducing device 702 designates such a transparent flat panel speaker 61 as shown in FIG. 1 by way of example, which reproduces the corresponding acoustic sound.

The sound source position control compiler 620 needs hardware information 703 like layout information at the transparent flat panel speaker group 60 of FIG. 1 by way of example in order to perform proper conversion. The criterion for conversion is similar to the spatial and temporal thresholds implemented by the hardware 700 in principle. The criterion for conversion conforms to the following first, second and third selection criteria in FIGS. 2 and 3, for example.

Firstly, the current position coordinates are selected where the present position coordinates are within the determination area 52. Secondly, when the present position coordinates are within the spatial threshold area 53a, the present position coordinates are selected unless the present position coordinates are adjacent to the previous position coordinates. When the present position coordinates are adjacent to the previous position coordinates, the previous position coordinates are selected. When, however, the short one (Ts) of the temporal thresholds is not reached, the selection of the present position coordinates is not performed. Thirdly, even when the present position coordinates are within the threshold area 53 and adjacent to the previous position coordinates, the present position coordinates are selected if the carry of the timer 44-5a is outputted beyond the temporal threshold (T1).

(Advantageous Effects of Fourth Embodiment)

According to the fourth embodiment, the following advantageous effects of (1) and (2) are further brought about in addition to advantageous effects approximately similar to the first and second embodiments.

(1) In accordance with the predetermined selection criterion, the moving pictures are played back using the sound source position control compiler 620 corresponding to the sound source position conversion software for designating the speaker 61 or the like which reproduces the acoustic sound. Therefore, the sound source position reproduction can be performed using the inexpensive hardware 700 without using expensive hardware, and the changing of the method for converting the sound source position can be easily achieved. If the inexpensive hardware is made small-sized, then a system most suitable for a hand-held game machine or the like can be presented.

(2) Since the moving pictures are reproduced using the MPEG4 application program which has the sound source position control compiler 620 and performs the acoustic video reproduction (630) and sound source position reproduction (640) in accordance with the settings of the spatial or temporal threshold, and the acoustic video information 651 and sound source position information 652 respectively. It is therefore possible to provide such an application program as to perform sound source position reproduction matched with the acoustic system. As a specific example of an application, there is also provided a gate program most suitable for the hand-held gate machine or the like as well as a simple player which performs moving-picture reproduction.

### Fifth Preferred Embodiment

The present invention is not limited to the above first through fourth embodiments. Various modifications can be made thereto. As the fifth embodiment corresponding to the modification, may be mentioned, for example, the following (A) and (B).

(A) If a moving-picture reproducing system utilizing sound source position information, according to the present invention is of a system capable of spatially superimposing a video reproducing device and a plurality of speakers on one another, then it can be adopted to all video acoustic systems in which sound sources producing their acoustic sounds are moved. As well as the liquid crystal display 50 having the transparent flat panel speakers 61, and the theater system, a transparent flat panel speaker analogous to a display antireflection film may be combined with a conventional cathode-ray tube (CRT) if a flat panel display is adopted, or a flat panel display may be taken which adopts a system much different from a liquid crystal as in the case of a plasma display and an EL display device.

(B) In a system which has combined a projector, a flat panel speaker group, a screen and a computer such as a PC or the like with one another, their combination can freely be selected. An application program on the computer such as the PC is not limited to a moving-picture playback player and can be adopted even to another application program with a video and voice. If the flat panel speaker group and the screen are configured integrally, then a compact projector system can be presented.

While the preferred forms of the present invention have been described, it is to be understood that modifications will be apparent to those skilled in the art without departing from the spirit of the invention. The scope of the invention is to be determined solely by the following claims.

1. A moving-picture reproducing system comprising:
a flat panel display which reproduces video information of a moving picture having the video information, acoustic sound information and sound source position information;
an acoustic sound reproducing device which reproduces the acoustic sound information of the moving picture and separates the same into a high-frequency acoustic sound and a low-frequency acoustic sound;
a high-audio speaker group which is disposed at a front or back of the flat panel display and comprises a plurality of high-audio speakers that play back the high-frequency acoustic sound;
low-audio speakers each of which reproduces the low-frequency acoustic sound; and
a sound source position reproducing device which reproduces the sound source position information of the moving picture and designates the corresponding high-audio speaker so as to reproduce the high-frequency acoustic sound, based on the sound source position information.

2. The moving-picture reproducing system according to claim 1, wherein the high-audio speaker group comprises a transparent flat panel speaker group constituted of a plurality of transparent flat panel speakers which are disposed at the front of the flat panel display and reproduce the high-frequency acoustic sound, and
wherein when an application program performs the reproduction of the moving picture to play back the video information, the acoustic sound information and the sound source position information, the sound source position reproducing device designates the corresponding transparent flat panel speaker so as to reproduce the high-frequency acoustic sound, based on the sound source position information.

3. The moving-picture reproducing system according to claim 1 or 2, which designates the corresponding high-audio speaker that reproduces the high-frequency acoustic sound.

4. The moving-picture reproducing system according to claim 1 or 2, wherein the sound source position reproducing device receives the acoustic sound information and the sound source position information therein,
compares present position coordinates and previous position coordinates related to the sound source position information,
determines whether the present position coordinates are placed in a spatial threshold area set per sound source position or an adjoining determination area, and
selects the present position coordinates from the result of determination as long as the present position coordinates are placed in the spatial threshold area and are not adjacent to the previous position coordinates, and designates the corresponding high-audio speaker reproducing the high-frequency acoustic sound, based on a criterion for selecting the previous position coordinates when a first threshold short in time, of the first threshold and a second threshold long in time is not reached.

5. The moving-picture reproducing system according to claim 1 or 2, wherein the sound source position reproducing device receives the acoustic sound information and the sound source position information therein,
compares present position coordinates and previous position coordinates related to the sound source position information,
determines whether the present position coordinates are placed in a spatial threshold area set per sound source position or an adjoining determination area, and
selects the previous position coordinates from the result of determination when the present position coordinates are placed in the spatial threshold area and are adjacent to the previous position coordinates, and designates the corresponding high-audio speaker reproducing the high-frequency acoustic sound, based on a criterion for selecting the present position coordinates when the present position coordinates exceed a second threshold long in time, of a first threshold short in time and the second threshold.

6. The moving-picture reproducing system according to claim 1 or 2, wherein the sound source position reproducing device includes,
buffers which receive the acoustic sound information and the sound source position information therein respectively,
a first register which stores present position coordinates related to the sound source position information therein,
a second register which stores previous position coordinates related to the sound source position coordinates,
a threshold determinator which determines from the present position coordinates whether the present position coordinates are placed in a spatial threshold area,
an adjacence determinator which compares the present position coordinates and the previous position coordinates and thereby determines whether the present position coordinates are placed in an adjoining area,
a multiplexer which selects either the present position coordinates or the previous position coordinates,
a gate circuit which controls the multiplexer, and
an acoustic signal splitter which makes a lead to the high-audio speaker for designating an acoustic signal, based on position coordinates selected by the multiplexer.

7. The moving-picture reproducing system according to claim 6, wherein the sound source position reproducing device has a plurality of channels respectively configured by the buffers, the first and second registers, the threshold determinator, the adjacence determinator, the multiplexer, the gate circuit and the acoustic signal splitter, and
wherein by means of the channel splitter, one or a plurality of the acoustic signals for the plural channels are connected to analog synthetic terminals of the channels each related to the designated high-audio speaker and analog-synthesized.

8. The moving-picture reproducing system according to claim 6, wherein the sound source position reproducing device has amplifiers which respectively amplify the analog-synthesized acoustic signals related to the respective high-audio speakers, and the respective amplifiers perform automatic gain control according to the input signals.

9. The moving-picture reproducing device according to claim 1, wherein the sound source position information is acquired such that the moving picture is reproduced on a computer, a sound source position of each character related to a video of the moving picture is tracked with each of cursors based on one or plural mice and the sound source position information is associated with an acoustic sound produced by the character.

10. The moving-picture reproducing system according to claim 9, wherein sound source position data having the acquired sound source position information is constructed which includes the designation of acoustic data corresponding to said each character, a playback base time, a sampling rate and plural position coordinates, and
wherein the sound source position reproducing device reproduces the sound source position, based on the sound source position data.

11. A moving-picture reproducing system comprising:
a projector which projects video information of a moving picture having the video information, acoustic sound information and sound source position information onto a screen;
an acoustic sound reproducing device which reproduces the acoustic sound information of the moving picture and separates the same into a high-frequency acoustic sound and a low-frequency acoustic sound;
a high-audio speaker group which is disposed at a back side of the screen and comprises a plurality of high-audio speakers that play back the high-frequency acoustic sound;
low-audio speakers each of which reproduces the low-frequency acoustic sound; and
a sound source position reproducing device which, when the projector reproduces the moving picture to play back a video, an acoustic sound and a sound source position of the moving picture, designates the corresponding high-audio speaker so as to reproduce the high-frequency acoustic sound, based on the sound source position.

12. A moving-picture reproducing system comprising:
a projector which projects video information of a moving picture having the video information, acoustic sound information and sound source position information on a screen;
an acoustic sound reproducing device which reproduces the acoustic sound information of the moving picture;
a speaker group comprising a plurality of speakers disposed at a back side of the screen;
a sound source position reproducing device which, when the moving picture is reproduced by software of a computer connected to the projector to play back a video, an acoustic sound and a sound source position of the moving picture, designates the corresponding speaker so as to reproduce the acoustic sound, based on the sound source position.

13. A moving-picture reproducing method comprising the steps of:
providing sound source position data having designation of corresponding acoustic data, a playback base time, a sampling rate and a plurality of position coordinates to a scene binary format system decoder as a moving picture experts group phase 4/elementary stream that belongs to an acoustic elementary stream related to the acoustic data; and setting a reproduced sound source position as an element for composition.

14. The moving-picture reproducing method according to claim 13, further comprising a step for setting a spatial position of an objective corresponding to the element for composition as the sound source position.

15. A moving-picture reproducing method comprising the following step of:
reproducing a moving picture using sound source position conversion software for designating a speaker for reproducing an acoustic sound, said sound source position conversion software converting sound source position information on the basis of hardware information, in accordance with selection criteria for firstly selecting present position coordinates when the present position coordinates fall into a determination area, secondly selecting the present position coordinates as long as the present position coordinates are not adjacent to previous position coordinates where the present position coordinates fall into a spatial threshold area and selecting the previous position coordinates when the present position coordinates are adjacent to the previous position coordinates, and unselecting the present position coordinates when a first threshold short in time, of the first threshold and a second threshold long in time, is not reached, and thirdly selecting the present position coordinates if a carry of a timer is outputted beyond the second threshold even when the present position coordinates fall into the threshold area and are adjacent to the previous position coordinates.

16. A moving-picture reproducing method comprising the following step of:
reproducing a moving picture using an application program having the sound source position conversion software as defined in claim 15, said application program performing acoustic video reproduction and sound source position reproduction respectively in accordance with the setting of the spatial or temporal threshold, and acoustic video information and sound source position information.
